(19) United States
(12) Patent Application Publication
(10) Pub. No.: US 2024/0134654 A1
(43) Pub. Date: Apr. 25, 2024

(54) NETWORK INTERFACE DEVICE BOOTING ONE OR MORE DEVICES

(71) Applicant: Intel Corporation, Santa Clara, CA (US)

(72) Inventors: Chinh T. CAO, Beaverton, OR (US); Mitchell WILLIAMS, Hillsboro, OR (US); Yashaswini Raghuram PRATHIVADI BHAYANKARAM, Hillsboro, OR (US)

(21) Appl. No.: 18/535,892

(22) Filed: Dec. 11, 2023

(51) Int. Cl. G06F 9/4401

(52) U.S. Cl. CPC G06F 9/4416; G06F 9/4406

(57) ABSTRACT

Examples described herein relate to a network interface device. In some examples, the network interface device includes a device interface; a direct memory access (DMA) circuitry; a network interface; a processor; and circuitry to boot from a network source, obtain one or more boot images from said network source, and subsequently operate as a network boot server for at least one other device.

### BACKGROUND

Preboot Execution Environment (PXE) (e.g., Preboot Execution Environment (PXE) Specification, Version 2.1 (1999)) describes a standardized manner in which a client boots a software assembly from a boot server via a network. If the client cannot be booted (e.g., there is no operating system (OS) installed, or the OS has failed in some manner), then the client can execute a Universal Extensible Firmware Interface (UEFI) application and utilize a PXE-capable network interface controller (NIC) to boot from a PXE boot server. FIG. 1 depicts an example prior art of boot of a server system by a PXE server.

A network interface device such as Infrastructure Processing Unit (IPU), data processing unit (DPU), or Smart NIC can include a general-purpose computer system, including a central processing unit (CPU), memory, storage, input/output (I/O) devices, etc. In connection with a boot operation, such network interface devices execute operating systems (OSs), which are installed prior to boot. Different customers and different use cases utilize different OSs with different configurations. As such, some network interface devices that execute OSs are not provisioned in the factory and are provisioned on-premises by an end-user by installing OSs on-premises. However, installing and configuring OSs and software on the network interface device and host system can be a time-consuming manual process that is error-prone.

### BRIEF DESCRIPTION OF THE DRAWINGS

FIG. 1 depicts an example prior art of boot.

FIG. 2 depicts an example system.

FIG. 3 depicts an example process.

FIG. 4 depicts an example process.

FIGS. 5A and 5B depict example network interface devices.

FIG. 6 depicts an example system.

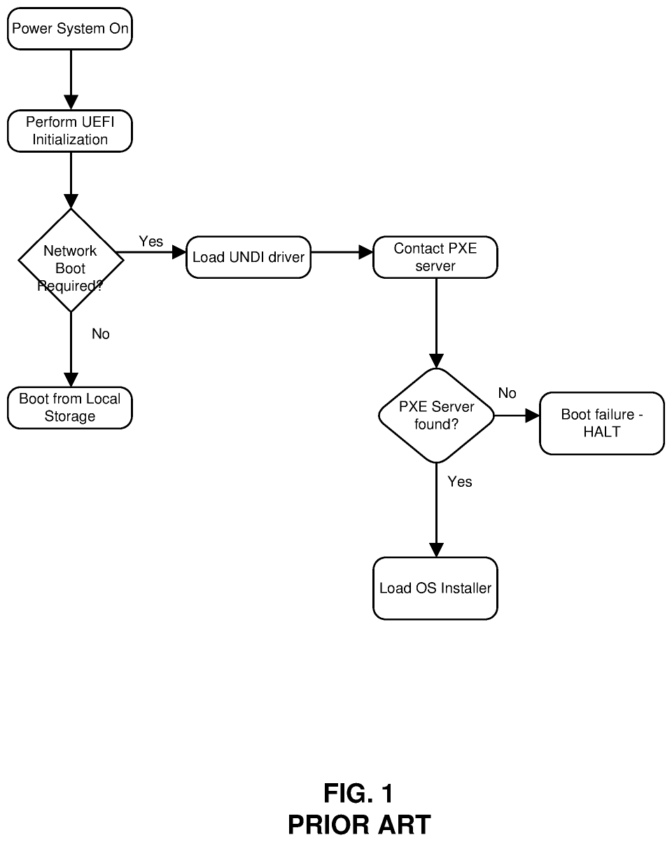

### DETAILED DESCRIPTION

At least to provide for provisioning or installing a boot firmware or software assembly in a network interface device and/or host system, on-premises or in another environment, where a host system is connected to a network interface device and either or both of the host system or the network interface device is/are not provisioned with boot firmware or an OS (e.g., the boot firmware or OS is corrupted, not approved for use, or not stored prior to or during boot), the network interface device can boot from a network source, obtain one or more boot images from the network source, and operate as a network boot server for at least one other device. For example, the boot server can include a server that is connected to the network interface device using a network and can transmit or receive packets consistent with Ethernet or other standard or proprietary protocols. For example, the at least one other device can include a server connected to the network interface device by a device interface and the server executes one or more processes that transmit and/or receive packets using the network interface device. For example, the at least one other device can include a second network interface device, a server connected to the network interface device by a network and accessible using packets consistent with Ethernet or other standard or proprietary protocols, a composite system formed from devices connected by a network, fabric, or interconnect and composed by the network interface device or an orchestrator, or other systems. For example, the one or more boot images can include one or more of: boot firmware, an operating system (OS), applications, configured applications, full disk image (e.g., processes, drivers, processes, device and process state), or others.

For example, the network interface device can receive boot images from another device as a PXE client and provide services of a PXE server to the another device by responding to PXE boot requests by providing boot images stored on the network interface device, or passing PXE boot requests to a PXE server to be serviced by a network accessible PXE server and forwarding responses from the network accessible PXE server to the another device. For example, a network interface device can configure, provision, initialize, and/or install boot images from a boot server for execution by the network interface device and execution by a connected host, as well as other servers and/or network interface devices. In some examples, the network interface device can access the PXE server to access boot images to provision the network interface device for boot. Next, the network interface device can provide a PXE boot service to the connected host system. Depending on a configuration, the network interface device can forward the request from the host system for boot images to the PXE server and provide the response from the PXE server (e.g., boot image and other software and configurations) to the host system, or provision the host system directly with boot images received from the PXE server and stored in the network interface device. When or after the host and the network interface device reboot, the host and the network interface device can be fully provisioned and ready to operate. References to PXE can instead refer to other system such as Hypertext Transfer Protocol (HTTP) boot, Serva 32/64, DHCP Server for Windows, ERPXE, Tiny PXE Server and TinyWeb, or other network boot services.

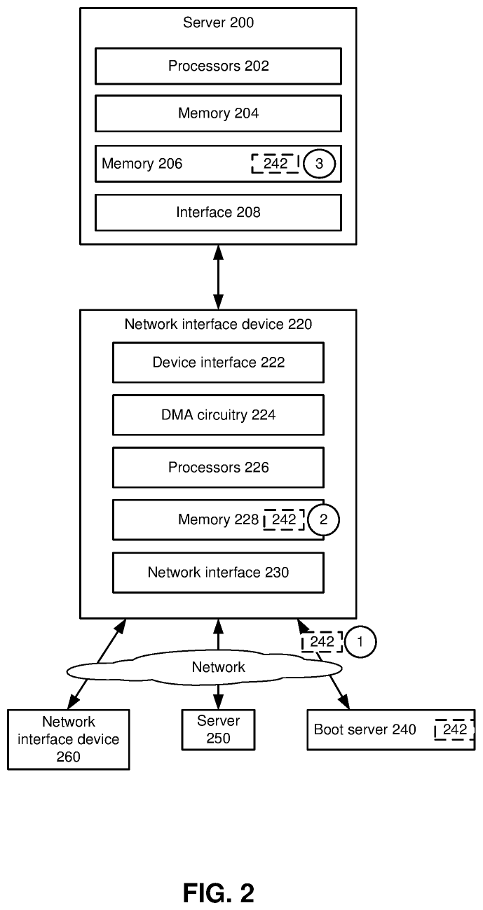

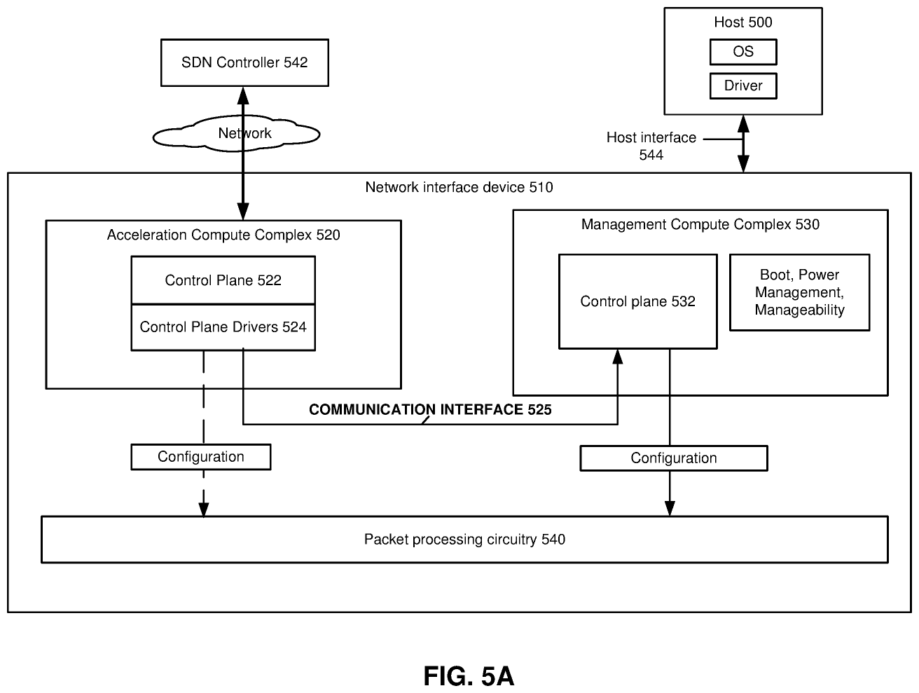

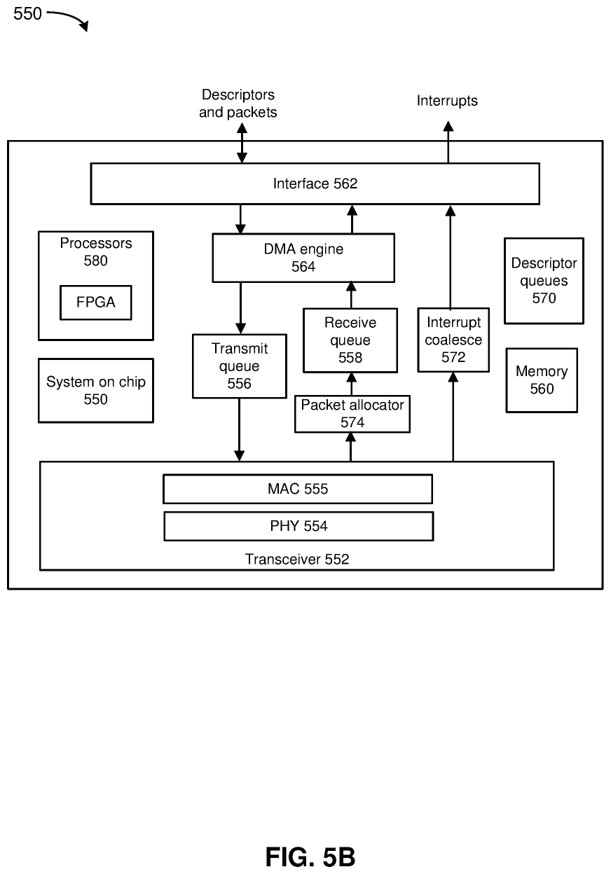

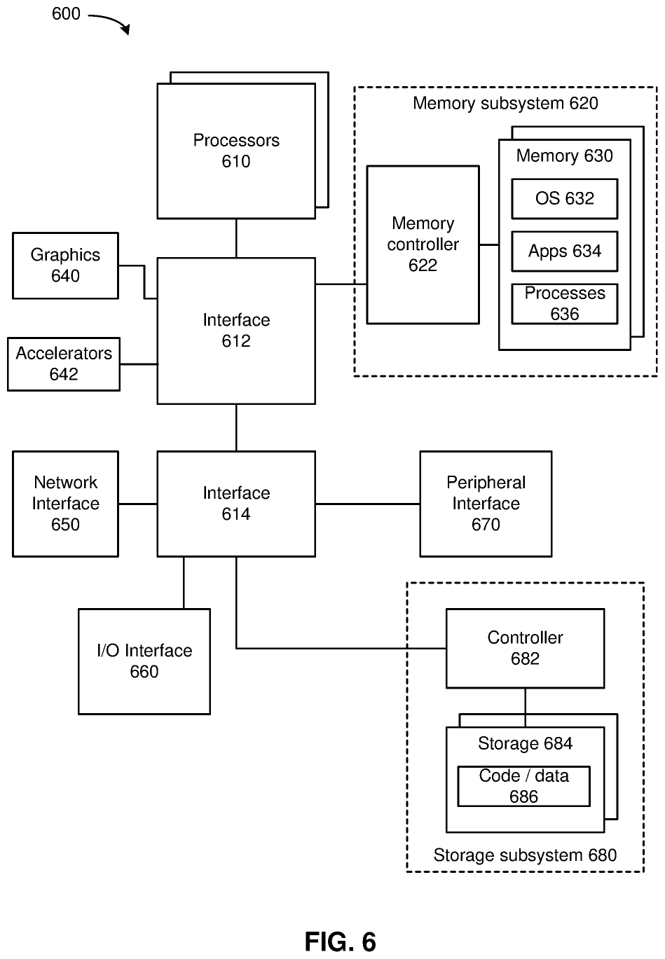

FIG. 2 depicts an example system. Server 200 can include one or more processors 202, memory 204, memory 206, and device interface 208. Server 200 can include circuitry and software described at least with respect to FIG. 6. Server 200 can be communicatively coupled to network interface device 220 by device interface 208 that is consistent at least with Peripheral Component Interconnect express (PCIe), Compute Express Link (CXL), or other protocols. Network interface device 220 can include device interface 222 for communication with device interface 208 of server 200, a direct memory access (DMA) circuitry 224 for copying data to server 200 and reading data from server 200, processors 226, memory 228, and network interface 230 for transmitting and receiving packets via a network. Various examples of network interface device 220 are described at least with respect to FIGS. 5A and 5B.

In some examples, network interface device 220 can include one or more of: a network interface controller (NIC), a remote direct memory access (RDMA)-enabled NIC, SmartNIC, router, switch, forwarding element, infrastructure processing unit (IPU), data processing unit (DPU), edge processing unit (EPU), or Amazon Web Services (AWS) Nitro Card. An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). A Nitro Card can include various circuitry to perform compression, decompression, encryption, or decryption operations as well as circuitry to perform input/output (I/O) operations.

Boot server 240 can provide boot images 242 to server 200 and network interface device 220. Boot server 240 can operate in a manner consistent with one or more of: PXE, HTTP boot (e.g., UEFI Specification V2.5 (2015)), Serva 32/64, DHCP Server for Windows, ERPXE, Tiny PXE Server and TinyWeb, or other network boot services. Boot images 242 can include one or more of: boot firmware or an operating system (OS), applications, configured applications, full disk image, (e.g., OS, processes, process state, device state, drivers, or other software or firmware), migration of a virtual machine or container environment, or others.

In some examples, boot firmware code or firmware can include one or more of: Basic Input/Output System (BIOS), Universal Extensible Firmware Interface (UEFI), or a boot loader. The BIOS firmware can be pre-installed on a personal computer's system board or accessible through an SPI interface from a boot storage (e.g., flash memory). In some examples, firmware can include SPS. In some examples, a Universal Extensible Firmware Interface (UEFI) can be used instead or in addition to a BIOS for booting or restarting cores or processors. UEFI is a specification that defines a software interface between an operating system and platform firmware. UEFI can read from entries from disk partitions by not just booting from a disk or storage but booting from a specific boot loader in a specific location on a specific disk or storage. UEFI can support remote diagnostics and repair of computers, even with no operating system installed. A boot loader can be written for UEFI and can be instructions that a boot code firmware can execute and the boot loader is to boot the operating system(s). A UEFI bootloader can be a bootloader capable of reading from a UEFI type firmware.

UEFI is a standard BIOS installed in every PC-compatible system; when the system is powered on, UEFI is what runs initially to wake the system up, run a self-test, and then boot the operating system. A UEFI capsule is a manner of encapsulating a binary image for firmware code updates. But in some examples, the UEFI capsule is used to update a runtime component of the firmware code. The UEFI capsule can include updatable binary images with relocatable Portable Executable (PE) file format for executable or dynamic linked library (dll) files based on COFF (Common Object File Format). For example, the UEFI capsule can include executable (*.exe) files. This UEFI capsule can be deployed to a target platform as an SMM image via existing OS specific techniques (e.g., Windows Update for Azure, or LVFS for Linux).

For example, boot server 240 can provide a network boot service for at least server 200 and network interface device 220 using network protocols including Dynamic Host Configuration Protocol (DHCP), a Trivial File Transfer Protocol (TFTP), Hypertext Transfer Protocol (HTTP), or others. For example, to perform a network boot, one or more of server 200, network interface device 220, server 250, and/or network interface device 260 can: execute a basic input/output system (BIOS) that initiates a PXE boot as a fallback option for failure to boot; transmit a DHCP request and a PXE request to boot server 240 or other boot server; receive a response the DHCP response and Internet Protocol (IP) address of the TFTP server and the file name of the network boot program (NBP); download and execute the NBP; and the NBP causes loading of configurations, scripts, and/or images to run an OS.

For example, to perform a network boot, one or more of server 200, network interface device 220, server 250, and/or network interface device 260 can: transmit a DHCP request containing an HTTP Boot identifier to boot server 240 or other boot server; receive a boot resource location in Uniform Resource Identifier (URI) format; access the NBP identified by the URI; utilize the HTTP protocol to download the NBP from the HTTP server; and execute the downloaded NBP image.

For example, network interface device 220 can be configured in a factory by a manufacturer with an installed software stack that includes at least a client and server software. Client and server software can include: a PXE client and a PXE server, as well as other software including, but not limited to, TFTP client/server software, and/or saved OS image for a host. On power-on or boot, network interface device 220 can provide a file (e.g., PXE executable file) to server 200 which pauses server 200 until network interface device 220 is able to configure network interface device 220 over the network with boot image 242 image from boot server 240. When or after network interface device 220 is configured with boot image 242, network interface device 220 can assist with booting server 200 based on a request for a boot image from server 200. Network interface device 220 can boot from boot server 240, obtain one or more boot images from boot server 240, and subsequently operate as a network boot server for at least one other device. For example, network interface device 220 can act as a boot server to server 200 on an internal network port, other servers, and/or other network interface devices. Network interface device 220 can perform operations of a boot server and provide boot images to one or more of: network interface device 220, server 200, other servers 250, and/or other network interface devices 260.

Depending on a configuration or on memory or storage available to network interface device 220, network interface device 220 may receive boot image 242 from boot server 240 and store boot image 242 in memory 228 accessible to network interface device 220. In that case, network interface device 220 can directly provision server 200 with boot image 242 as a boot server. Depending on the configuration or if storage on network interface device 220 is insufficient to store boot image 242 for server 200 or another device, then server 200 can pass through the requests for boot images from server 200 (or other device) to boot server 240, allowing server 200 to be configured from boot server 240 on the network.

In operation, at (1), based on receipt of a request from network interface device 220 for a boot image, boot server 240 can provide boot image 242 to network interface device 220. At (2), based on validation of boot image 242 (e.g., verification of a checksum), network interface device 220 can store boot image 242 into memory 228 for access and utilization to boot one or more of processors 226. At (3), network interface device 220 can provide image 242 to memory 206 of server 200 for access and boot of one or more of processors 202.

From the point of view of a network administrator, boot firmware provisioning of server 200 and network interface device 220 occurs in a single action at initial power-on of server 200. Once the system is physically installed and connected to the network, no additional hands-on time may be utilized.

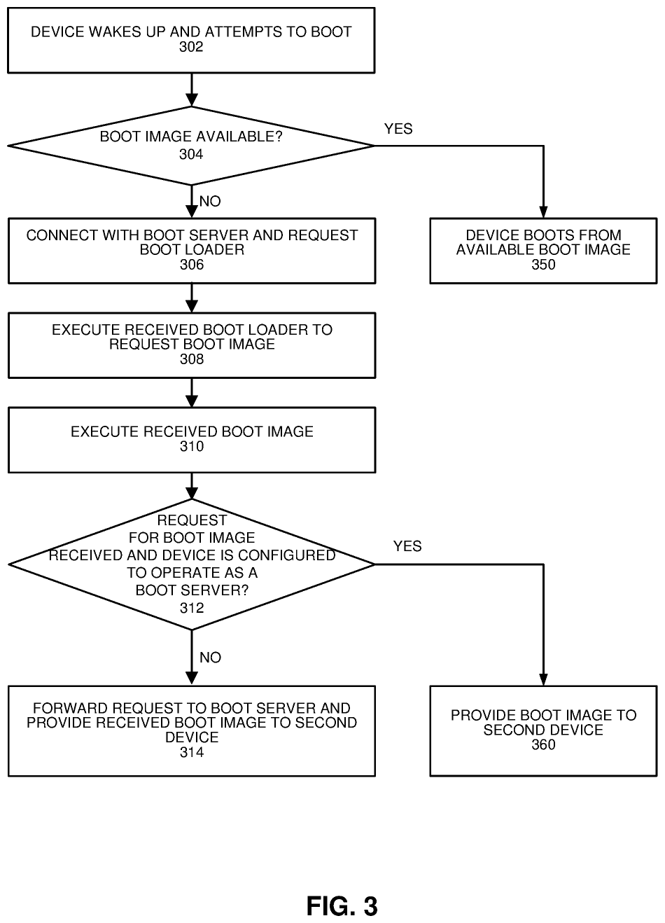

FIG. 3 depicts an example process. The process can be performed by a device, such as a host system, network interface device, or other device. At 302, the device wakes up and attempts to boot. A processor of the device can attempt to perform a UEFI initialization, which can include waking system up, performing a self-test, searching for a boot image, and so forth. At 304, the processor of the device can determine whether a boot image is available or the processor of the device is unable to boot. Based on a determination that a boot image is available, the process can proceed to 350, where the device can boot using the available boot image. Based on a determination that boot image is not available, the process can proceed to 306.

At 306, a processor of the device can load a driver to communicate with a boot server. For example, the processor can load a Universal Network Device Interface (UNDI) driver to communicate with a boot server. At 306, based on successful connection with a boot server, the processor can request the boot server for a boot loader process. For example, where the boot server operates in a manner consistent with PXE, the processor can request a PXE executable and the device can receive the PXE executable from the boot server. At 308, the processor can execute a boot loader, which can cause requesting and downloading at least one boot image from the boot server into memory accessible to the processor. At 310, the processor can execute the received at least one boot image.

At 312, a request can be received from a second device for boot image from the boot server. The second device can include a host system, a network connected host system, a network interface device, or other device. The processor can intercept the communication to the boot server, for example. For example, based on the PXE specification, the boot server can provide OS options and other boot image options to the second device. Based on the device being configured to interact as a boot server with the second device, at 360, the device can perform boot server operations for the second device and provide a stored boot image to the second device. However, based on the device not being configured to interact as a boot server with the second device or not storing the requested boot image, at 314, the device can request the particular boot image from the boot server. Based on receipt of the boot image from the boot server, the device can provide boot the image to the second device. The second device can execute the boot image provided by the network interface device.

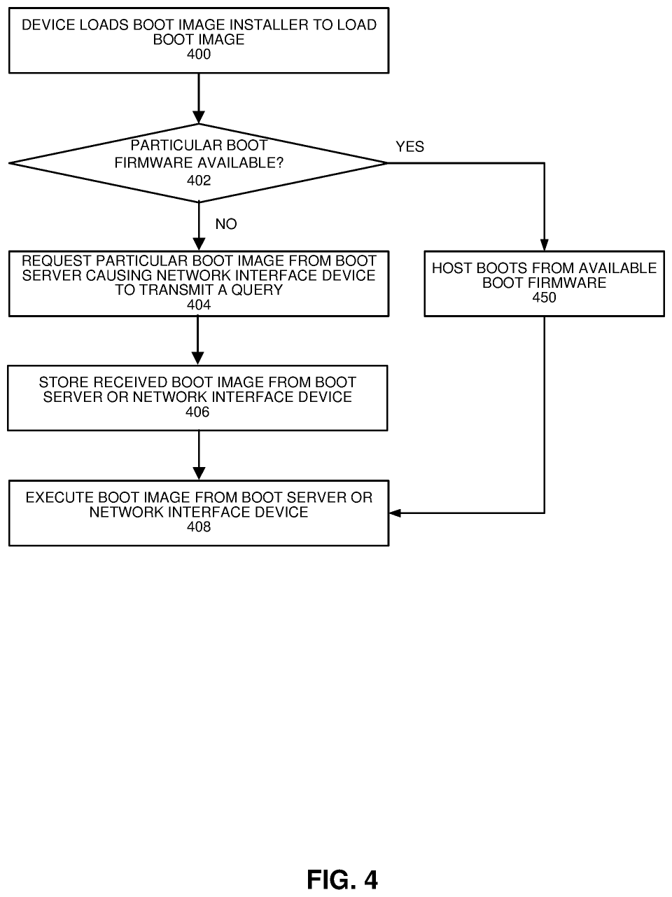

FIG. 4 depicts an example process. The process can be performed by a device, such as a host system, network interface device, or other device. At 400, based on boot of host, host can load a boot image installer (e.g., pre-boot execution environment for management and deployment, UEFI application, or others) in order to load a boot image. At 402, a determination can be made as to whether the boot image is available for access by a processor of the device. At boot, the device can execute UEFI BIOS, which loads a driver (e.g., Universal Network Device Interface (UNDI) driver) to cause a network interface device to search for a boot server. At 404, based on inability to access a boot image, the device can cause transmission of a request for a particular boot image to the boot server through the network interface device. The particular boot image can be identified by a host system. At or prior to boot of the host system, a user can be presented with available boot images and select a particular boot image or a script can select a particular boot image and the network interface device can report the selected boot image to a boot server and the boot server can send the particular boot image to the network interface device.

At 406, based on receipt of a boot image, the device can store the boot image. The boot image can be loaded from the network interface device in some examples. However, based on non-receipt of the boot image, an error can be indicated or the device can cause the network interface device to issue another request for the boot image to the boot server. At 408, the device can execute the stored particular boot image.

Referring again to 402, based on ability for the device to access a particular boot image from memory or the network interface device, at 450, the device can boot from the particular boot image stored in memory of the device or provided by the network interface device. For example, if the network interface device stores the requested particular boot image, then the network interface device can provide the particular boot image to the device. The process can continue to 408, where the device can execute the particular boot image.

FIG. 5A depicts an example system. Host 500 can include processors, memory devices, device interfaces, as well as other circuitry such as described with respect to one or more of FIG. 5B, and/or 6. Processors of host 500 can execute software such as applications (e.g., microservices, virtual machine (VMs), microVMs, containers, processes, threads, or other virtualized execution environments), operating system (OS), and device drivers. An OS or device driver can configure network interface device or packet processing device 510 to perform operations of a boot server for one or more devices (e.g., host systems or network interface devices).

Packet processing device 510 can include multiple compute complexes, such as an Acceleration Compute Complex (ACC) 520 and Management Compute Complex (MCC) 530, as well as packet processing circuitry 540 and network interface technologies for communication with other devices via a network. ACC 520 can be implemented as one or more of: a microprocessor, processor, accelerator, field programmable gate array (FPGA), application specific integrated circuit (ASIC) or circuitry described at least with respect to FIG. 5B, and/or 6. Similarly, MCC 530 can be implemented as one or more of: a microprocessor, processor, accelerator, field programmable gate array (FPGA), application specific integrated circuit (ASIC) or circuitry described at least with respect to FIG. 5B, and/or 6. In some examples, ACC 520 and MCC 530 can be implemented as separate cores in a CPU, different cores in different CPUs, different processors in a same integrated circuit, different processors in different integrated circuit.

Packet processing device 510 can be implemented as one or more of: a microprocessor, processor, accelerator, field programmable gate array (FPGA), application specific integrated circuit (ASIC) or circuitry described at least with respect to FIG. 5B, and/or 6. Packet processing pipeline circuitry 540 can process packets as directed or configured by one or more control planes executed by multiple compute complexes. In some examples, ACC 520 and MCC 530 can execute respective control planes 522 and 532.

As described herein, packet processing device 510, ACC 520, and/or MCC 530 can be configured to request and receive boot images from a boot server and/or perform operations of a boot server to one or more devices, including host 500.

SDN controller 542 can upgrade or reconfigure software executing on ACC 520 (e.g., control plane 522 and/or control plane 532) through contents of packets received through packet processing device 510. In some examples, ACC 520 can execute control plane operating system (OS) (e.g., Linux) and/or a control plane application 522 (e.g., user space or kernel modules) used by SDN controller 542 to configure operation of packet processing pipeline 540. Control plane application 522 can incude Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 542 can communicate with ACC 520 using a remote procedure call (RPC) such as Google remote procedure call (gRPC) or other service and ACC 520 can convert the request to target specific protocol buffer (protobuf) request to MCC 530. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 542 can provide packet processing rules for performance by ACC 520. For example, ACC 520 can program table rules (e.g., header field match and corresponding action) applied by packet processing pipeline circuitry 540 based on change in policy and changes in VMs, containers, microservices, applications, or other processes. ACC 520 can be configured to provide network policy as flow cache rules into a table to configure operation of packet processing pipeline 540. For example, the ACC-executed control plane application 522 can configure rule tables applied by packet processing pipeline circuitry 540 with rules to define a traffic destination based on packet type and content. ACC 520 can program table rules (e.g., match-action) into memory accessible to packet processing pipeline circuitry 540 based on change in policy and changes in VMs.

For example, ACC 520 can execute a virtual switch such as vSwitch or Open vSwitch (OVS), Stratum, or Vector Packet Processing (VPP) that provides communications between virtual machines executed by host 500 or with other devices connected to a network. For example, ACC 520 can configure packet processing pipeline circuitry 540 as to which VM is to receive traffic and what kind of traffic a VM can transmit. For example, packet processing pipeline circuitry 540 can execute a virtual switch such as vSwitch or Open vSwitch that provides communications between virtual machines executed by host 500 and packet processing device 510.

MCC 530 can execute a host management control plane, global resource manager, and perform hardware registers configuration. Control plane 532 executed by MCC 530 can perform provisioning and configuration of packet processing circuitry 540. For example, a VM executing on host 500 can utilize packet processing device 510 to receive or transmit packet traffic. MCC 530 can execute boot, power, management, and manageability software (SW) or firmware (FW) code to boot and initialize the packet processing device 510, manage the device power consumption, provide connectivity to Baseboard Management Controller (BMC), and other operations.

One or both control planes of ACC 520 and MCC 530 can define traffic routing table content and network topology applied by packet processing circuitry 540 to select a path of a packet in a network to a next hop or to a destination network-connected device. For example, a VM executing on host 500 can utilize packet processing device 510 to receive or transmit packet traffic.

ACC 520 can execute control plane drivers to communicate with MCC 530. At least to provide a configuration and provisioning interface between control planes 522 and 532, communication interface 525 can provide control-plane-to-control plane communications. Control plane 532 can perform a gatekeeper operation for configuration of shared resources. For example, via communication interface 525, ACC control plane 522 can communicate with control plane 532 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 525 can be utilized by a negotiation protocol and configuration protocol running between ACC control plane 522 and MCC control plane 532. Communication interface 525 can include a general purpose mailbox for different operations performed by packet processing circuitry 540. Examples of operations of packet processing circuitry 540 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 525 can include one or more mailboxes accessible as registers or memory addresses. For communications from control plane 522 to control plane 532, communications can be written to the one or more mailboxes by control plane drivers 524. For communications from control plane 532 to control plane 522, communications can be written to the one or more mailboxes. Communications written to mailboxes can include descriptors which include message opcode, message error, message parameters, and other information. Communications written to mailboxes can include defined format messages that convey data.

Communication interface 525 can provide communications based on writes or reads to particular memory addresses (e.g., dynamic random access memory (DRAM)), registers, other mailbox that is written-to and read-from to pass commands and data. To provide for secure communications between control planes 522 and 532, registers and memory addresses (and memory address translations) for communications can be available only to be written to or read from by control planes 522 and 532 or cloud service provider (CSP) software executing on ACC 520 and device vendor software, embedded software, or firmware executing on MCC 530. Communication interface 525 can support communications between multiple different compute complexes such as from host 500 to MCC 530, host 500 to ACC 520, MCC 530 to ACC 520, baseboard management controller (BMC) to MCC 530, BMC to ACC 520, or BMC to host 500.

Packet processing circuitry 540 can be implemented using one or more of: application specific integrated circuit (ASIC), field programmable gate array (FPGA), processors executing software, or other circuitry. Control plane 522 and/or 532 can configure packet processing pipeline circuitry 540 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 520 or MCC 530. In some examples, a P4 program can be compiled and provided to MCC 530 to configure packet processing circuitry 540. The following is a JSON configuration file that can be transmitted from ACC 520 to MCC 530 to get capabilities of packet processing circuitry 540 and/or other circuitry in packet processing device 510. More particularly, the file can be used to specify a number of transmit queues, number of receive queues, number of supported traffic classes (TC), number of available interrupt vectors, number of available virtual ports and the types of the ports, size of allocated memory, supported parser profiles, exact match table profiles, packet mirroring profiles, among others.

FIG. 5B depicts an example network interface device or packet processing device. In some examples, circuitry of network interface device can be utilized by network interface 510 (FIG. 5A) or another network interface for packet transmissions and packet receipts associated with requests for a boot image to a boot server or responses from the boot server, as described herein. In some examples, network interface device 550 can be implemented as a network interface controller, network interface card, a host fabric interface (HFI), or host bus adapter (HBA), and such examples can be interchangeable. Packet processing device 550 can be coupled to one or more servers using a bus, PCIe, CXL, or Double Data Rate (DDR). Packet processing device 550 may be embodied as part of a system-on-a-chip (SoC) that includes one or more processors, or included on a multichip package that also contains one or more processors.

Some examples of network interface device 550 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 550 can include transceiver 552, transmit queue 556, receive queue 558, memory 560, host interface 562, DMA engine 564, and processors 580. Transceiver 552 can be capable of receiving and transmitting packets in conformance with the applicable protocols such as Ethernet as described in IEEE 802.3, although other protocols may be used. Transceiver 552 can receive and transmit packets from and to a network via a network medium (not depicted). Transceiver 552 can include PHY circuitry 554 and media access control (MAC) circuitry 555. PHY circuitry 554 can include encoding and decoding circuitry (not shown) to encode and decode data packets according to applicable physical layer specifications or standards. MAC circuitry 555 can be configured to assemble data to be transmitted into packets, that include destination and source addresses along with network control information and error detection hash values.

Processors 580 can be any a combination of a: processor, core, graphics processing unit (GPU), field programmable gate array (FPGA), application specific integrated circuit (ASIC), or other programmable hardware device that allow programming of network interface 550. For example, a “smart network interface” can provide packet processing capabilities in the network interface using processors 580.

Processors 580 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 580, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

Packet allocator 574 can provide distribution of received packets for processing by multiple CPUs or cores using timeslot allocation described herein or RSS. When packet allocator 574 uses RSS, packet allocator 574 can calculate a hash or make another determination based on contents of a received packet to determine which CPU or core is to process a packet.

Interrupt coalesce 572 can perform interrupt moderation whereby network interface interrupt coalesce 572 waits for multiple packets to arrive, or for a time-out to expire, before generating an interrupt to host system to process received packet(s). Receive Segment Coalescing (RSC) can be performed by network interface 550 whereby portions of incoming packets are combined into segments of a packet. Network interface 550 provides this coalesced packet to an application.

Direct memory access (DMA) engine 564 can copy a packet header, packet payload, and/or descriptor directly from host memory to the network interface or vice versa, instead of copying the packet to an intermediate buffer at the host and then using another copy operation from the intermediate buffer to the destination buffer.

Memory 560 can be any type of volatile or non-volatile memory device and can store any queue or instructions used to program network interface 550. Transmit queue 556 can include data or references to data for transmission by network interface. Receive queue 558 can include data or references to data that was received by network interface from a network. Descriptor queues 570 can include descriptors that reference data or packets in transmit queue 556 or receive queue 558. Host interface 562 can provide an interface with host device (not depicted). For example, host interface 562 can be compatible with PCI, PCI Express, PCI-x, Serial ATA, and/or USB compatible interface (although other interconnection standards may be used).

FIG. 6 depicts a system. In some examples, circuitry of a network interface device can be utilized to request a boot image from a boot server or provide a boot image to one or more processors, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 can drive a display that provides an output to a user. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. Memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others, or compatible with reduced instruction set computer (RISC) instruction set architecture (ISA) (e.g., RISC-V). In some examples, OS 632 can configure network interface 650 to provide services of a boot server for processors 610.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described with respect to FIG. 5A or 5B.

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory is memory whose state (and therefore the data stored in it) is indeterminate if power is interrupted to the device. A non-volatile memory (NVM) device is a memory whose state is determinate even if power is interrupted to the device.

In an example, system 600 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 600 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes: a network interface device comprising: a device interface; a direct memory access (DMA) circuitry; a network interface; a processor; and circuitry to boot from a network source, obtain one or more boot images from said network source, and subsequently operate as a network boot server for at least one other device.

Example 2 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

Example 3 includes one or more examples, wherein the circuitry is to provide network boot services to a host system.

Example 4 includes one or more examples, wherein the circuitry is to provide network boot services to a second system or a second network interface device.

Example 5 includes one or more examples, wherein the at least one other device comprises a composite system formed from devices connected by a network, fabric, or interconnect.

Example 6 includes one or more examples, wherein the one or more boot images comprise one or more of: boot firmware, an operating system (OS), an application, full disk image, driver, process state, device state, or virtual machine migration.

Example 7 includes one or more examples, wherein the network boot server is to operate in a manner consistent with one or more of: Preboot Execution Environment (PXE), Hypertext Transfer Protocol (HTTP) boot, Serva 32/64, DHCP Server for Windows, ERPXE, or Tiny PXE Server and TinyWeb.

Example 8 includes one or more examples, and includes at least one non-transitory computer-readable medium comprising instructions stored thereon, that if executed by one or more processors, cause the one or more processors of a network interface device to: based on inability of a processor of the one or more processors to access a boot software for execution, request the boot software from a network boot server; intercept a request for the boot software from a host system received via a device interface; and provide the boot software to the host system via the device interface for execution by the host system, wherein the boot software comprises one or more of: boot firmware or an operating system (OS).

Example 9 includes one or more examples, and includes instructions stored thereon, that if executed by one or more processors, cause the one or more processors of a network interface device to: communicate, as the network boot server, with the host system.

Example 10 includes one or more examples, and includes instructions stored thereon, that if executed by one or more processors, cause the one or more processors of a network interface device to: intercept a communication from the host system to the network boot server and provide boot software options to the host system.

Example 11 includes one or more examples, wherein the boot software comprises one or more of: a Basic Input/Output System (BIOS), Universal Extensible Firmware Interface (UEFI), a boot loader, or an operating system (OS).

Example 12 includes one or more examples, wherein the network boot server is to operate in a manner consistent with one or more of: Preboot Execution Environment (PXE), Hypertext Transfer Protocol (HTTP) boot, Serva 32/64, DHCP Server for Windows, ERPXE, or Tiny PXE Server and TinyWeb.

Example 13 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

Example 14 includes one or more examples, and includes a method that includes: a network interface device performing: retrieving boot software from a boot software server and installing the boot software for execution by a processor of the network interface device and a host system connected to the network interface device via a device interface, wherein the boot software comprises one or more of: boot firmware or an operating system (OS) and wherein the network interface device comprises: the device interface; a direct memory access (DMA) circuitry; a network interface; and the processor.

Example 15 includes one or more examples, and includes the network interface device performing: based on boot of the processor and inability for a processor of the host system to access a boot software for execution, requesting the boot software from the boot software server; intercepting a request for the boot software from the host system received via a device interface; and providing the boot software to the host system via the device interface for execution by the host system.

Example 16 includes one or more examples, and includes the network interface device communicating with the host system as the boot software server.

Example 17 includes one or more examples, and includes the network interface device intercepting a communication from the host system to the network interface device and providing boot software options to the host system.

Example 18 includes one or more examples, wherein the boot software comprises one or more of: a Basic Input/Output System (BIOS), Universal Extensible Firmware Interface (UEFI), or a boot loader.

Example 19 includes one or more examples, wherein the boot software server is to operate in a manner consistent with one or more of: Preboot Execution Environment (PXE), Hypertext Transfer Protocol (HTTP) boot, Serva 32/64, DHCP Server for Windows, ERPXE, or Tiny PXE Server and TinyWeb.

Example 20 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

1. An apparatus comprising:
a network interface device comprising:
a device interface;
a direct memory access (DMA) circuitry;
a network interface;
a processor; and
circuitry to boot from a network source, obtain one or more boot images from said network source, and subsequently operate as a network boot server for at least one other device.

2. The apparatus of claim 1, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

3. The apparatus of claim 1, wherein the circuitry is to provide network boot services to a host system.

4. The apparatus of claim 1, wherein the circuitry is to provide network boot services to a second system or a second network interface device.

5. The apparatus of claim 1, wherein the at least one other device comprises a composite system formed from devices connected by a network, fabric, or interconnect.

6. The apparatus of claim 1, wherein the one or more boot images comprise one or more of: boot firmware, an operating system (OS), an application, full disk image, driver, process state, device state, or virtual machine migration.

7. The apparatus of claim 1, wherein the network boot server is to operate in a manner consistent with one or more of: Preboot Execution Environment (PXE), Hypertext Transfer Protocol (HTTP) boot, Serva 32/64, DHCP Server for Windows, ERPXE, or Tiny PXE Server and TinyWeb.

8. At least one non-transitory computer-readable medium comprising instructions stored thereon, that if executed by one or more processors, cause the one or more processors of a network interface device to:
based on inability of a processor of the one or more processors to access a boot software for execution, request the boot software from a network boot server;
intercept a request for the boot software from a host system received via a device interface; and
provide the boot software to the host system via the device interface for execution by the host system, wherein the boot software comprises one or more of: boot firmware or an operating system (OS).

9. The non-transitory computer-readable medium of claim 8, comprising instructions stored thereon, that if executed by one or more processors, cause the one or more processors of a network interface device to:
communicate, as the network boot server, with the host system.

10. The non-transitory computer-readable medium of claim 8, comprising instructions stored thereon, that if executed by one or more processors, cause the one or more processors of a network interface device to:
intercept a communication from the host system to the network boot server and provide boot software options to the host system.

11. The non-transitory computer-readable medium of claim 8, wherein the boot software comprises one or more of: a Basic Input/Output System (BIOS), Universal Extensible Firmware Interface (UEFI), a boot loader, or an operating system (OS).

12. The non-transitory computer-readable medium of claim 8, wherein the network boot server is to operate in a manner consistent with one or more of: Preboot Execution Environment (PXE), Hypertext Transfer Protocol (HTTP) boot, Serva 32/64, DHCP Server for Windows, ERPXE, or Tiny PXE Server and TinyWeb.

13. The non-transitory computer-readable medium of claim 8, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

14. A method comprising:
a network interface device performing:
retrieving boot software from a boot software server and installing the boot software for execution by a processor of the network interface device and a host system connected to the network interface device via a device interface, wherein the boot software comprises one or more of: boot firmware or an operating system (OS) and wherein the network interface device comprises: the device interface; a direct memory access (DMA) circuitry; a network interface; and the processor.

15. The method of claim 14, comprising:
the network interface device performing:
based on boot of the processor and inability for a processor of the host system to access a boot software for execution, requesting the boot software from the boot software server;
intercepting a request for the boot software from the host system received via a device interface; and
providing the boot software to the host system via the device interface for execution by the host system.

16. The method of claim 15, comprising:
the network interface device communicating with the host system as the boot software server.

17. The method of claim 15, comprising:
the network interface device intercepting a communication from the host system to the network interface device and providing boot software options to the host system.

18. The method of claim 15, wherein the boot software comprises one or more of: a Basic Input/Output System (BIOS), Universal Extensible Firmware Interface (UEFI), or a boot loader.

19. The method of claim 15, wherein the boot software server is to operate in a manner consistent with one or more of: Preboot Execution Environment (PXE), Hypertext Transfer Protocol (HTTP) boot, Serva 32/64, DHCP Server for Windows, ERPXE, or Tiny PXE Server and TinyWeb.

20. The method of claim 15, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).
